(19) United States
(12) Patent Application Publication
(10) Pub. No.: US 2003/0084433 A1
(43) Pub. Date: May 1, 2003

(54) Profile-guided stride prefetching

(76) Inventors: Chi-Keung Luk, Shrewsbury, MA (US); Harish Patil, Shrewsbury, MA (US); Robert Muth, Brookline, MA (US); Paul Geoffrey Lowney, Concord, MA (US); Robert Cohn, Salem, NH (US); Richard Weiss, Montague, MA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 09/999,889

(22) Filed: Oct. 31, 2001

(51) Int. Cl. G06F 9/45

(52) U.S. Cl. 717/158

(57) ABSTRACT

Executable code is modified to include prefetch instructions for certain loads. The targeted loads preferably include those loads for which a compiler cannot compute a stride (which represents the difference in memory addresses used in consecutive executions of a given load). Whether prefetch instructions should be included for such loads is determined preferably by running the code with a training data set which determines the frequency of strides for each subsequent execution of a load. If a stride occurs more than once for a load, then that load is prefetched by inserting a prefetch instruction into the executable code for that load. Further, a stride value is associated with the inserted prefetch. Preferably, the stride value is the most frequently occurring stride, which can be determined based on the results of the training data set. Alternatively, the stride can be computed during run-time by the code itself.

### CROSS-REFERENCE TO RELATED APPLICATIONS

Not Applicable.

### STATEMENT REGARDING FEDERALLY SPONSORED RESEARCH OR DEVELOPMENT

Not applicable.

### BACKGROUND OF THE INVENTION

1. Field of the Invention

The present invention generally relates to microprocessors. More particularly, the present invention relates to data prefetching during program flow to minimize cache misses. More particularly still, the invention uses profiling to determine address strides that are not compile-time constant.

2. Background of the Invention

Most modern computer systems include at least one central processing unit (“CPU”) and a main memory. Multiprocessor systems include more than one processor and each processor typically has its own memory which may or may not be shared by other processors. The speed at which the CPU can decode and execute instructions and operands depends upon the rate at which the instructions and operands can be transferred from main memory to the CPU. In an attempt to reduce the time required for the CPU to obtain instructions and operands from main memory, many computer systems include a cache memory coupled between the CPU and main memory.

A cache memory is a relatively small, high-speed memory (compared to main memory) buffer that is used to temporarily hold those portions of the contents of main memory which it is believed will be used in the near future by the CPU. The main purpose of a cache is to shorten the time necessary to perform memory accesses, both for data and instructions. Cache memory typically has access times that are several or many times faster than a system's main memory. The use of cache memory can significantly improve system performance by reducing data access time, therefore permitting the CPU to spend far less time waiting for instructions and operands to be fetched and/or stored.

A cache memory, typically comprising some form of random access memory (“RAM”) includes many blocks (also called lines) of one or more words of data. Associated with each cache block in the cache is a tag. The tag provides information for mapping the cache line data to its main memory address. Each time the processor makes a memory reference (i.e., read or write), a tag value from the memory address is compared to the tags in the cache to see if a copy of the requested data resides in the cache. If the desired memory block resides in the cache, then the cache's copy of the data is used in the memory transaction, instead of the main memory's copy of the same data block. However, if the desired data block is not in the cache, the block must be retrieved from the main memory and supplied to the processor. A copy of the data also is stored in the cache.

Because the time required to retrieve data from main memory is substantially longer than the time required to retrieve data from cache memory, it is highly desirable have a high cache hit rate. Although cache subsystems advantageously increase the performance of a processor, not all memory references result in a cache hit. A cache miss occurs when the targeted memory data has not been cached and must be retrieved from main memory. Thus, cache misses detrimentally impact the performance of the processor, while cache hits increase the performance.

One well-known technique to reduce the opportunities for cache misses is “prefetching.” Prefetching will be explained in the context of load instructions in which data is to be retrieved from a particular address from memory. It is often the case that a load instruction is executed multiple times, such as in a loop, and each time through the loop the memory reference address is incremented by a static number. For example, a load instruction might be executed multiple times to retrieve data from memory address X the first time, address X+2 the second time, address X+4 the third time, X+6 the fourth time, and so on. As such, each time the load is executed, the previous memory reference is incremented by 2. In this example, the load instruction is said to have a “stride” of 2. A compiler can be designed to analyze the source code to detect such condition in which the stride is static and thus known at compile-time.

Armed with this information, the compiler can insert “prefetch” instructions into the program to cause data needed in a future iteration of the load command to be fetched from memory and stored in cache before that particular data is needed. In other words, a prefetch instruction anticipates the need for a data value by a future execution of a load, fetches that data value from main memory and stores it in cache. Then, when the load executes for that particular data value, the data is retrieved from cache memory instead of the longer latency main memory. By way of example, while the load from memory address X+2 is being executed, a prefetch can be executed to retrieve the data at location X+6. Then, when the load instruction is executed to retrieve the data at location X+6, the requested data has already been cached and advantageously no cache miss results.

Unfortunately, not all loads have a static stride and that can be determined during the compile process. Thus, not all loads can be benefit from the aforementioned prefetch technique. Accordingly, any improvement in prefetch techniques would be highly desirable.

### BRIEF SUMMARY OF THE INVENTION

The problems noted above are solved in large part by modifying executable code to include prefetch instructions for certain loads. The targeted loads preferably include those loads for which a compiler cannot compute a stride. Such loads, nevertheless, may have a repeatable stride that can be determined when running the code. Accordingly, whether prefetch instructions should be included for such loads is determined preferably by running the code with a training data set which determines the frequency of strides for each subsequent execution of pre-selected loads. If a stride occurs more than once for a load, then that load is prefetched by inserting a prefetch instruction into the executable code for that load. Further, a stride value is associated with the inserted prefetch that the prefetch uses to compute a memory address from which to fetch data. Preferably, the stride value is the most frequently occurring stride, which can be determined based on the results of the training data set. Alternatively, the stride can be computed during run-time by the code itself.

Accordingly, in accordance with one embodiment of the invention, the invention includes a method of modifying executable software comprising instrumenting the software to collect information regarding load instructions, running a predetermined data set through said instrumented software, and determining whether to insert a prefetch instruction for a load instruction based on the result of data set execution. In accordance with another embodiment, the method includes determining the difference between memory addresses used in consecutive executions of a load instruction, determining the frequency of occurrence of said differences for said load instruction, and inserting a prefetch instruction for said load instruction if a difference occurs more than once for said load instruction.

If desired, a cost/benefit analysis can be performed to help decide whether to prefetch a load. This decision can be made by comparing the latency associated with performing the load instruction with and without a prefetch against the latency of the prefetch itself. If the difference in latency between the load with and without a prefetch is greater than the latency of the prefetch (i.e., the number of cycles taken to retire the prefetch), then the load instruction is prefetched.

These and other benefits will become apparent upon reviewing the following disclosure.

### BRIEF DESCRIPTION OF THE DRAWINGS

For a detailed description of the preferred embodiments of the invention, reference will now be made to the accompanying drawings in which:

FIG. 1 is a diagram of a computer system constructed in accordance with the preferred embodiment of the invention and including a simultaneous and multithreaded processor;

FIG. 2 shows a method of inserting prefetch instructions into a program based on a profile of the program's load instructions in accordance with a preferred embodiment of the invention; and

FIG. 3 illustrates an example of how prefetch instructions can be inserted into the program.

### NOTATION AND NOMENCLATURE

Certain terms are used throughout the following description and claims to refer to particular system components. As one skilled in the art will appreciate, microprocessor companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections. The term “stride” refers to the difference between memory addresses used for consecutive executions of a given load instruction. For example, if a first execution of a load instruction is for address X and the next execution of the same address is for address X+4, the stride for that pair of consecutive executions is 4.

To the extent that any term is not specially defined in this specification, the intent is that the term is to be given its plain and ordinary meaning.

### DETAILED DESCRIPTION OF THE PREFERRED EMBODIMENTS

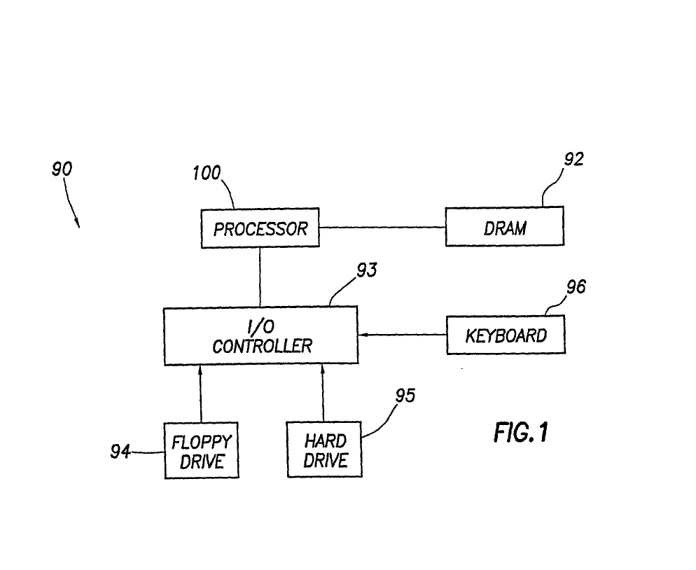

In accordance with a preferred embodiment of the invention, it has been observed that certain load instructions that are executed multiple times may result during run-time in repeated strides of the same value, but strides that cannot be determined during compile-time. For example, a load instruction that accesses a value from a “linked list.” A linked list is a well-known, generally non-contiguous data structure that is allocated during run-time in perhaps non-contiguous blocks of memory of varying sizes and locations in memory. It is not known during compile-time where and how large a linked list will be in memory—it is created “on the fly” during run-time. In a linked-list access, a pointer is used to point to a location that contains a memory address from where the requested data is accessed. As this type of load instruction is repeatedly executed, the memory address from where data is taken may be incremented, but the incremental stride value cannot be determined during compile-time—it is only known during run-time. In accordance with the preferred embodiment of the invention, certain load instructions in a program thus are analyzed during run-time to determine if there is a repeatable stride value associated with each subsequent execution of the load instruction and, if so, a prefetch instruction is inserted into the program associated with the load instruction. This technique may also be used in combination with the conventional compiler-based prefetch technique described above in which the compiler determines loads that have statically determinable strides. The preferred technique will be described in greater detail below with regard to FIGS. 1-3.

Referring now to FIG. 1, a computer system 90 is shown including a processor 100 which may be a multithreaded or other type of processor. Besides processor 100, computer system 90 may also include dynamic random access memory (“DRAM”) 92, an input/output (“I/O”) controller 93, and various I/O devices which may include a floppy drive 94, a hard drive 95, a keyboard 96, and the like. The I/O controller 93 provides an interface between processor 100 and the various I/O devices 94-96. The DRAM 92 can be any suitable type of memory devices such as RAMBUS™ memory. In addition, the processor 100 may also be coupled to one or more other processors if desired.

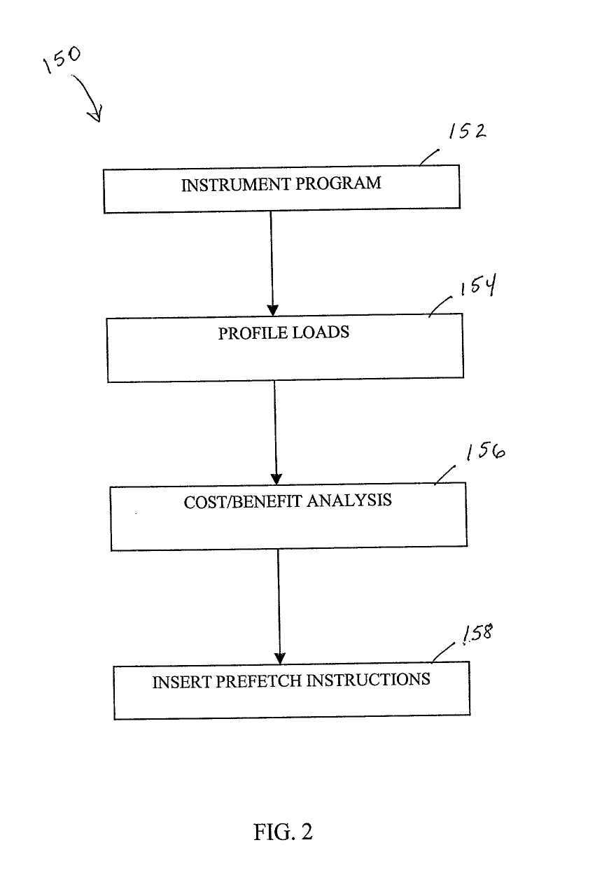

FIG. 2 shows a preferred method 150 of modifying a program to include prefetch instructions associated with load instructions that have a stride that is determinable during run-time (i.e., not compile-time). Of course, if desired, the preferred technique can be used to determine static strides (i.e., strides that are determinable during compile time). Alternatively, as noted above, the preferred technique can be used for prefetching loads that do not have compile-time determinable strides and a conventional compile-time-based prefetch technique can be used to prefetch compile-time determinable strides.

The method shown in FIG. 2 includes steps 152, 154, 156, and 158. In step 152, a program is instrumented to collect information that indicates the frequency of a particular stride for a given load instruction. Because, as noted above, certain load instructions have strides that are the same from one execution of the load to the next, but that are only determinable during run-time, instrumentation step 152 helps to determine which loads have this characteristic. This step first includes determining which types of load instructions should be instrumented to acquire the stride frequency information. In general, loads that are likely to miss in the cache are suitable candidates. Also, loads that have relatively high load latencies and/or retire delays may also be suitable candidates. Other types of loads may not be suitable candidates, such as loads that are not directly involved in a program loop, loads with loop-invariant addresses, loads that share the same cache lines with other recently executed loads, and loads that are already prefetched by the compiler. Additional or different types of loads may be instrumented to detect stride frequency. The loads that may be selected for instrumentation preferably are determined by analyzing the source or object code in light of the various criteria used to determine load instructions suitable for instrumentation, such as the criteria listed above. Any suitable off-the-shelf or custom written software tool can be used to perform the instrumentation step 152. Generally, the instrumentation includes monitoring the targeted load instructions so that the memory addresses used by the loads can be captured and used to calculate the differences between addresses used in successive memory references (i.e., strides).

In step 154 the program's object code is “profiled” to collect information from which decisions can be made as for which loads to include prefetches. “Profiling” refers to the process of collecting data about the execution of the program to determine if any load instructions would benefit from being prefetched. In accordance with one embodiment of the invention, the instrumented object code is run on any suitable training data set and various statistics are acquired and/or computed from the program's execution. One suitable statistic that can be collected is the frequency of each stride for each load instruction that has been instrumented to collect such data. This means that for each instrumented load, the stride for each pair of consecutively executed iterations of a load is determined and collected. Then, the number of times each stride occurs is determined. For example, if a particular load is executed 11 times, there will be 10 strides associated with the 11 pairs of consecutively executed loads. If a stride of 4 occurred four times, a stride of 8 occurred three times, a stride of 16 occurred two times, and a stride 24 occurred once, then a stride of 4 occurred more often than all other strides for that particular load. This analysis preferably is performed for all loads instrumented in step 152 and, accordingly, a stride profile is determined for the instrumented load instructions.

Referring still to FIG. 2, step 156 may be performed to determine, based on the statistics determined in step 154, whether a given load should be prefetched. It should be noted that the cost/benefit analysis of step 156 is optional. If step 156 is omitted, then each instrumented load preferably is prefetched if a particular stride value occurs more frequently than all other stride values. In the example in the preceding paragraph, the load instrumentation would be prefetched for a stride value of 4. If two or more stride values occur for a given load with equal frequency, it may be decided not to prefetch the load or to prefetch the load for any of such stride values. In this latter case, a stride value can be randomly selected from the most frequent stride occurrences. Alternatively, the lowest or highest stride value can be used or any other suitable methodology for selecting a stride value from a plurality of equally frequent strides can be used.

Including a cost/benefit analysis (step 156) means that a determination as to whether a load should be prefetched is made by examining the benefit of load prefetching versus the cost in including the prefetches. The benefits generally includes reducing the number of cache misses and the latency involved with such cache misses. The costs generally include the overhead associated with prefetch instructions, the additional memory bandwidth consumed by useless prefetches (i.e., prefetches that retrieve data from a memory location that turns out to be an incorrect address), and data cache pollution due to useless prefetches.

Any suitable technique for performing the analysis of step 156 is acceptable and within the scope of this disclosure. One suitable cost/benefit analysis is to compare the extra latency that can be tolerated by a prefetch against the instruction overhead of the prefetch itself. For example, assuming that without a prefetch, a load takes X cycles to fetch the data on average, with a prefetch, the load would take Y cycles to fetch the data on average (Y is expected to be less than X), and each prefetch takes N cycles to finish (i.e., N is the number of cycles needed to retire the prefetch), then a prefetch would be issued for the load if (X−Y)>N. Alternatively stated, this type of analysis favors prefetching a load if the data can be prefetched and then loaded in fewer clock cycles than it would take to load the data from memory without a prefetch.

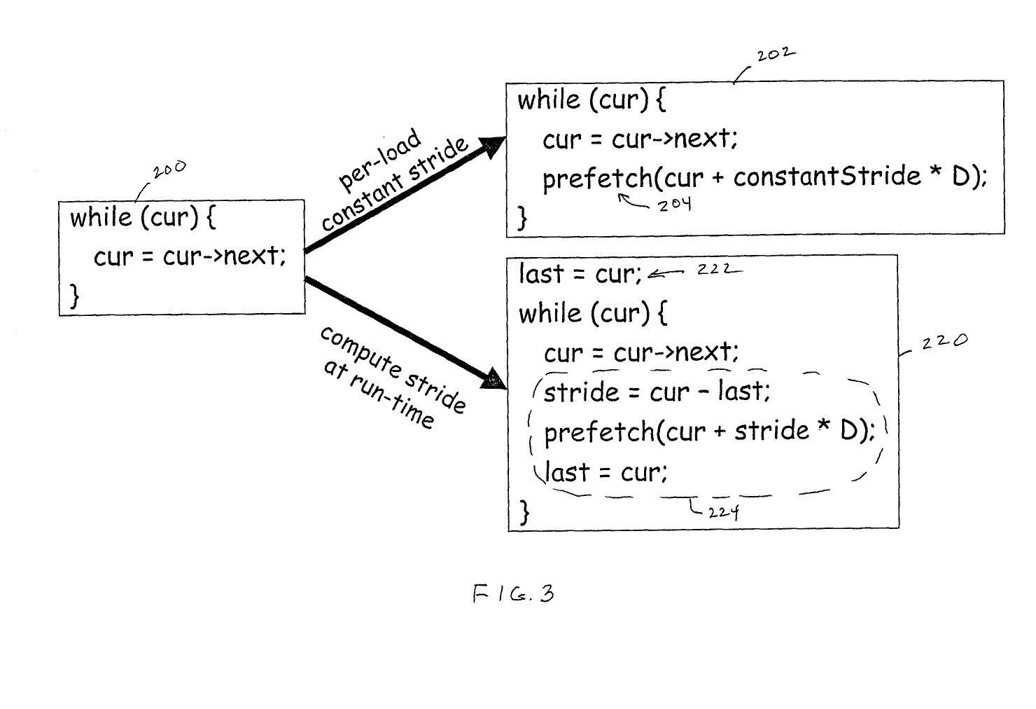

Finally, in FIG. 2, for those load instructions for which prefetching is determined to be warranted, prefetch instructions are inserted into the object code (step 158). This step is performed using any suitable binary rewriting tool which permits prefetch instructions to be inserted into the code according to the stride profile determined above. FIG. 3 shows two exemplary techniques for inserting prefetches based on the stride profile for a given load. In FIG. 3, a code segment 200 is shown containing a memory reference (cur=cur next). Also shown in FIG. 3 are two versions of that code segment both of which have been modified to include a load prefetch. In version 202, a prefetch instruction 204 is added in which data is prefetched based on a constant stride value that is determined according to the procedure described above with regard to FIG. 2. This technique is referred to as “per-load constant stride” because it uses a constant stride value that is uniquely determined for that particular load based, for example, on the most frequently occurring stride value for the load. Using this technique, prefetches are inserted into the object before the program is run.

The other technique shown in FIG. 3 is represented in code segment 220. In this version, instructions 222 and 224 have been added to the code segment. Instruction 222 initially sets the variable “last” to the “cur” variable. Then, the instruction 224 computes a stride value, performs a prefetch based on that stride and resets the “last” variable. This technique dynamically computes a stride value for a load during run-time. This technique differs from that illustrated by code segment 202 in that in segment 220 stride values are not known until the program is run, whereas in code segment 202 the stride values are determined prior to run-time. The technique embodied in code segment 220 can capture multiple strides for a single load, but requires extra instruction overhead for calculating the strides. Further, the technique in segment 220 in which the stride is computed during run-time is particularly useful when stride profiling finds multiple strides for the load instruction. In short, profiling facilitates a determination as to whether prefetching would be beneficial or not, but the stride is computed during run-time, not before as with the code segment 202.

As discussed above, the preferred embodiment provides a technique by which it can be determined during run-time whether it would be worthwhile prefetch a load instruction. This technique can be used for any load instruction, but preferably is used for loads for which a compiler cannot make this determination. Accordingly, the preferred embodiment of the invention provides a significant performance increase in a processor.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method of modifying executable software, comprising:
(a) instrumenting said software to collect information regarding load instructions;
(b) running a predetermined data set through said instrumented software to collect information regarding said load instructions; and
(c) determining whether to insert a prefetch instruction for a load instruction based on said information.

2. The method of claim 1 further including performing an analysis of the cost associated with a prefetch instruction versus the benefit of a prefetch instruction and making the determination in (c) based on said cost/benefit analysis.

3. The method of claim 1 wherein said prefetch instruction is inserted in (c) if (X−Y)>N, wherein X is the number of clock cycles to fetch data with the load if no prefetch instruction is inserted, Y is the number of clock cycles to fetch data with the load if a prefetch instruction is inserted, and N is the number of clock cycles needed to retire the prefetch instruction.

4. The method of claim 1 further including determining the most frequently occurring stride value for said load instruction using the results of (b), a stride value being the difference between memory addresses used during two consecutive executions of said load instruction.

5. The method of claim 4 further including inserting a prefetch instruction into said software associated with said load instruction, said prefetch instruction using the most frequently occurring stride value for said load instruction.

6. A method of modifying executable software, comprising:
(a) determining the difference between pairs of memory addresses used in consecutive executions of a load instruction;
(b) determining the frequency of occurrence of said differences for said load instruction; and
(c) inserting a prefetch instruction for said load instruction if a difference occurs more than once for said load instruction.

7. The method of claim 6 further including associating before run-time a difference with the inserted prefetch instruction, said difference being the most frequently occurring difference.

8. The method of claim 6 further including computing during run-time a difference to be associated with the inserted prefetch instruction.

9. The method of claim 6 wherein said prefetch instruction is inserted in (c) after considering the latency associated with such a prefetch instruction.

10. The method of claim 6 wherein said prefetch instruction is inserted in (c) if (X−Y)>N, wherein X is the number of clock cycles to fetch data with the load if no prefetch instruction is inserted, Y is the number of clock cycles to fetch data with the load if a prefetch instruction is inserted, and N is the number of clock cycles needed to retire the prefetch instruction.

11. A computer system, comprising:
a processor;
an I/O controller coupled to said processor;
an I/O device coupled to said I/O controller; and
memory coupled to said processor, said memory including software executed by said processor, wherein said software has been modified prior to run-time to include a prefetch instruction associated with a load instruction by instrumenting said software to collect information regarding load instructions, running a predetermined data set through said instrumented software, and inserting the prefetch instruction if a stride associated with said load occurs more than once.

12. The computer system of claim 11 wherein said software modification also occurs by performing an analysis of the cost associated with the prefetch instruction versus the benefit of a prefetch instruction and inserting the prefetch instruction if the benefit outweighs the cost.

13. The computer system of claim 11 wherein said prefetch instruction is inserted in if (X−Y)>N, wherein X is the number of clock cycles to fetch data with the load if no prefetch instruction is inserted, Y is the number of clock cycles to fetch data with the load if a prefetch instruction is inserted, and N is the number of clock cycles to prefetch the data.

14. The computer system of claim 11 wherein said software modification also occurs by determining the most frequently occurring stride value for said load instruction.

15. The computer system of claim 14 wherein said prefetch instruction is inserted into said software, said prefetch instruction using the most frequently occurring stride value.

16. A computer system, comprising:
a processor;
an I/O controller coupled to said processor;
an I/O device coupled to said I/O controller; and
memory coupled to said processor, said memory including software executed by said processor, wherein said software has been modified prior to run-time to include a prefetch instruction associated with a load instruction by determining the difference between memory addresses used in consecutive executions of a load instruction, determining the frequency of occurrence of said differences for said load instruction, and inserting a prefetch instruction for said load instruction if a difference occurs more than once for said load instruction.

17. The computer system of claim 16 wherein said software modification occurs by associating, before run-time, a difference with the inserted prefetch instruction, said difference being the most frequently occurring difference for the load instruction.

18. The computer system of claim 16 wherein said software modification occurs by inserting stride computing instructions in addition to said prefetch instruction, said stride computing instructions permit a difference to be computed during run-time that is associated with the inserted prefetch instruction.

19. The computer system of claim 16 wherein said prefetch instruction is inserted during the software modification after considering the latency associated with such a prefetch instruction.

20. The computer system of claim 16 wherein said prefetch instruction is inserted during the software modification if (X−Y)>N, wherein X is the number of clock cycles to fetch data with the load if no prefetch instruction is inserted, Y is the number of clock cycles to fetch data with the load if a prefetch instruction is inserted, and N is the number of clock cycles to prefetch the data.
